(19) United States
(12) Patent Application Publication
(10) Pub. No.: US 2014/0265926 A1
(43) Pub. Date: Sep. 18, 2014

(54) ILLUMINATION APPARATUS WITH GRADUALLY CHANGEABLE COLOR TEMPERATURES

(71) Applicant: National Taiwan University of Science and Technology, Taipei City (TW)

(72) Inventors: Neng-chung Hu, Taipei City (TW); Chin-chuan Wu, Taipei City (TW); Yen-cheng Feng, Taipei City (TW)

(73) Assignee: National Taiwan University of Science and Technology, Taipei City (TW)

(21) Appl. No.: 13/969,568

(22) Filed: Aug. 18, 2013

(30) Foreign Application Priority Data
Mar. 15, 2013 (TW) 102109342

(51) Int. Cl. H05B 33/08

(52) U.S. Cl. CPC H05B 33/086
USPC 315/297; 315/307

(57) ABSTRACT

The present invention provides an illumination apparatus with gradually changeable color temperatures; the apparatus includes an illumination module and a control module. The illumination module is utilized to generate an illuminating light which has a plurality of different color temperatures. The control module is utilized to control a color temperature variation of the illuminating light so that a color difference in Duv corresponding to the variation of the illuminating light is less than 0.006 under the color temperature variation. Moreover, all color rendering indices of the illuminating light corresponding to the different color temperatures are larger than 90, thereby completely simulating the variation of sun.

### CROSS-REFERENCE

This application claims the priority of Taiwan Patent Application No. 102109342, filed on Mar. 15, 2013.

### TECHNICAL FIELD OF THE INVENTION

The present invention relates to an illumination apparatus, and especially to an illumination apparatus with gradually changeable color temperatures.

### BACKGROUND OF THE INVENTION

At present, a lamp that adopts RGB light-emitting diodes (LEDs) for performing color mixing has been made on the market, but such lamp generally is just applicable for ambience and background illumination. The main reason for this is a color rendering index of illuminating light of the RGB LEDs is less than 70, and it does not meet a standard of ENERGY STAR which the color rendering index for indoor illumination should be larger than 80.

In addition, color temperatures of the illuminating light exhibited by the conventional tunable lamp generally are about 2800K, 4000K, and 6500K. Such color-tunable lamp are created by using the RGB LEDs, or blue and red LEDs doping yellow phosphors, thereby constructing a color temperature tunable LED lamp. However, all of the color temperatures for that product do not meet the requirement that the color rendering index qualified for Energy Star should be larger than 80. Moreover, because there are only the three color temperatures for modulation, vision of an user can not adapt immediately when the different color temperatures of the illuminating light change, usually causing discomfort.

As for other applications such as light therapy, the color-tunable lamp can be used as a dawn simulator, which the brightness of white light changes with time, to alleviate depression, especially seasonal affective disorder, and adjust biological clock. However, at present, the light used in the light therapy usually has bright monochromatic light such as blue or white light with high brightness, or has a few variations of the color temperature. It can not completely simulate the variation of the color temperatures and the brightness of sun from dawn to dusk.

### SUMMARY OF THE INVENTION

Accordingly, an objective of the present invention is to provide an illumination apparatus with gradually changeable color temperatures, which can emit illuminating light with multiple variations of the color temperatures and without detection by a human body. Furthermore, color rendering index of every color temperature is larger than 90. In addition, the illumination apparatus of the present invention is capable of modulating suitable brightness and color temperature variation to completely simulate the sunlight.

To achieve the foregoing objective, according to an aspect of the present invention, the present invention provides an illumination apparatus with gradually changeable color temperatures; the apparatus includes an illumination module and a control module. The illumination module is utilized to generate an illuminating light which has a plurality of different color temperatures. The control module is utilized to control a color temperature variation of the illuminating light so that a color difference in Duv (difference unit in a color space) corresponding to the variation of the illuminating light is less than 0.006 under the color temperature variation. Moreover, all color rendering indices of the illuminating light corresponding to the different color temperatures are larger than 90.

In one preferred embodiment, the color temperature variation is selected from the group consisting of changes between two arbitrarily adjacent color temperatures from 1600K, 1651K, 1705K, 1762K, 1822K, 1886K, 1954K, 2027K, 2105K, 2188K, 2277K, 2373K, 2476K, 2587K, 2700K, 2836K, 3000K, 3128K, 3293K, 3500K, 3666K, 3878K, 4000K, 4362K, 4500K, 5000K, 5288K, 5700K, 6098K, 6500K, 7147K, 7803K, 8582K, 9529K, 10711K, 12242K, 14322K, 17350K, and 20000K.

In the preferred embodiment, the control module is further utilized to control a brightness variation of the illuminating light. Specifically, the control module controls the color temperatures of the illuminating light to successively vary from 1600K to 12000K, and the brightness variation corresponding to the color temperatures meets an S-curve. In addition, the control module controls the color temperatures of the illuminating light to successively vary from 12000K to 1600K, and the brightness variation corresponding to the color temperatures meets an inverted S-curve.

In another preferred embodiment, the control module controls the color temperatures of the illuminating light to linearly vary from 1600K to 12000K, and the color temperatures of the illuminating light linearly varies from 1600K to 12000K from 13:30 to 15:30.

In one preferred embodiment, the illumination module includes a combination of light sources, the combination of light sources comprising: a first LED whose main wavelength is 448 nm±20 nm; a second LED whose main wavelength is 505 nm±20 nm; a third LED whose main wavelength is 562 nm±20 nm; and a fourth LED whose main wavelength is 619 nm±20 nm. More specifically, the illumination module further includes a driving module which is electrically coupled to the combination of light sources and the control module. The driving module is utilized to drive the LEDs to illuminate and to control luminous energy distributions of the LEDs according to the control module for emitting the illuminating light with the color temperatures and the brightness.

In accordance with the illumination apparatus with gradually changeable color temperatures, the combination of light sources gradually emits the illuminating light of the multiple color temperatures, and the color rendering index of the illuminating light of each color temperature is larger than 90. Moreover, the color difference in Duv of each change of the illuminating light is less than 0.006; thus, it is not detected by the human body. In addition, the illumination apparatus of the present invention is further capable of controlling the color temperatures of the illuminating light to successively vary from 1600K to 12000K, and the brightness variation corresponding to the color temperatures meets the S-curve, thereby completely simulating the variation of dawn. Similarly, the illumination apparatus of the present invention is further capable of controlling the color temperatures of the illuminating light to successively vary from 12000K to 1600K, and the brightness variation corresponding to the color temperatures meets the inverted S-curve, thereby completely simulating the variation of dusk. Moreover, the illuminating light whose color temperature linearly varies from 1600K to 12000K further can be used to ease sleep in the afternoon.

It is to be understood that both the foregoing general description and the following detailed description of the present invention are exemplary and explanatory and are intended to provide further explanation of the invention as claimed:

### BRIEF DESCRIPTION OF THE DRAWINGS

FIG. 1 is a block diagram illustrating an illumination apparatus with gradually changeable color temperatures according to one preferred embodiment of the present invention;

FIG. 2 is an xy chromaticity diagram of an illuminating light having a plurality of different color temperatures emitted by an illumination module;

FIG. 3 is a table of the color temperatures;

FIG. 4 is a drawing illustrating a brightness variation of the illuminating light emitted from the illumination module for simulating the variation of dawn; and

FIG. 5 is a drawing illustrating a brightness variation of the illuminating light emitted from the illumination module for simulating the variation of dusk.

### DETAILED DESCRIPTION OF THE INVENTION

The following will explain the illumination apparatus with gradually changeable color temperatures according to a preferred embodiment of the present invention in detail with drawings. Referring to FIG. 1, FIG. 1 is a block diagram illustrating an illumination apparatus with gradually changeable color temperatures according to one preferred embodiment of the present invention. The illumination apparatus 100 of the embodiment includes an illumination module 120 and a control module 140. The illumination module 120 is utilized to generate an illuminating light which has a plurality of different color temperatures. Preferably, the illumination module 120 includes a combination of light sources 124 and a driving module 126. In the embodiment, the combination of light sources 124 includes a first LED 1241, a second LED 1242, a third LED 1243, and a fourth LED 1244. However, the present invention does not limit the illumination module 120 to be implemented only by the LEDs. Other devices such as organic light-emitting diode (OLED) having luminescence properties also can be implemented in the present invention.

More specifically, a main wavelength of the first LED 1241 is 448 nm±20 nm; a main wavelength of the second LED 1242 is 505 nm±20 nm; a main wavelength of the third LED 1243 is 562 nm±20 nm; and a main wavelength of the fourth LED 1244 is 619 nm±20 nm. Moreover, the above-mentioned four LEDs are closely stamped on a same circuit board (not shown), thereby reaching a better color mixing effect. It is worth mentioning that the arrangement of the above-mentioned four LEDs is not limited in the present invention.

As shown in FIG. 1, the driving module 126 is electrically coupled to the combination of light sources 124 and the control module 140. Specifically, the driving module 126 is electrically coupled respectively to the first LED 1241, the second LED 1242, the third LED 1243 and the fourth LED 1244. The driving module 126 is utilized to drive the LEDs to illuminate and to control luminous energy distributions of the LEDs according to the control module 140 for emitting the illuminating light with the color temperatures and the brightness. Specifically, the driving module 126 can be a micro processor, and the micro processor can synchronously output four pulse width modulation (PWM) signals respectively to the LEDs, thereby adjusting and controlling the luminous energy distributions of the first LED 1241, the second LED 1242, the third LED 1243 and the fourth LED 1244. When the LEDs receive the suitable PWM signals, the LEDs are capable of emitting the illuminating light with the multiple color temperatures; moreover, each illuminating light is capable of meeting the requirement that the color rendering index qualified for Energy Star should be larger than 80. Furthermore, by suitably allocating the energy distribution of each LED, all the color rendering indices of the illuminating light with the different color temperatures emitted from the combination of light sources 124 of the embodiment are larger than 90. Accordingly, the illumination apparatus 100 with gradually changeable color temperatures according to the embodiment has an excellent illuminating effect.

What follows is a detail of the working manner with respect to the control module 140. Referring to FIG. 2 and FIG. 3, FIG. 2 is an xy chromaticity diagram of the illuminating light having a plurality of different color temperatures emitted by the illumination module 120; FIG. 3 is a table of the color temperatures. The control module 140 is utilized to control the color temperature variation of the illuminating light so that a color difference in Duv corresponding to the variation of the illuminating light is less than 0.006 under the color temperature variation. Referring to FIG. 1 and FIG. 2, the control module 140 controls the driving module 126 for the driving module 126 emitting the suitable PWM signals to drive the combination of light sources 124 (i.e. main wavelengths 448 nm, 505 nm, 562 nm, and 619 nm) for the color mixing for generating the illuminating light with the plurality of different color temperatures. The illuminating light with the plurality of different color temperatures herein is positioned at a track (path) 200 of blackbody radiation on the xy chromaticity diagram. The representing illuminating light for each of the color temperatures is indicated as “x” on the xy chromaticity diagram. Preferably, the color temperatures successively vary from reddish 1600K to bluish 20000K.

The control module 140 of the embodiment is capable of controlling the color temperature variation of the illuminating light, so that the color difference in Duv between the variation of the illuminating light is less than 0.006, thereby making that not be detected by the human body, so as to reach the effect of gradually changeable color temperatures. As shown in FIG. 3, in the embodiment, FIG. 3 shows maximal variations of the color temperatures from 1600K to 20000K under a condition that the color difference in Duv does not exceed 0.006. In short, the color temperature variation is selected from the group consisting of changes between two arbitrarily adjacent color temperatures from 1600K, 1651K, 1705K, 1762K, 1822K, 1886K, 1954K, 2027K, 2105K, 2188K, 2277K, 2373K, 2476K, 2587K, 2700K, 2836K, 3000K, 3128K, 3293K, 3500K, 3666K, 3878K, 4000K, 4362K, 4500K, 5000K, 5288K, 5700K, 6098K, 6500K, 7147K, 7803K, 8582K, 9529K, 10711K, 12242K, 14322K, 17350K, and 20000K. However, in other embodiments, different light source has their different values of the color temperature variations. The desired table of the variations of the color temperatures can be obtained by converting every xy chromaticity coordinate on the xy chromaticity diagram into an uv coordinate and then comparing whether a distance between the two adjacent uv coordinates is less than 0.006. The specific steps thereof are not described in details herein.

Referring to FIG. 4 and FIG. 5, FIG. 4 is a drawing illustrating a brightness variation of the illuminating light emitted from the illumination module 120 for simulating the variation of dawn; FIG. 5 is a drawing illustrating a brightness variation of the illuminating light emitted from the illumination module 120 for simulating the variation of dusk. In order to simulate the variation of sun from dawn to dusk, the control module 140 is further utilized to control a brightness variation of the illuminating light.

Specifically, when the illumination apparatus 100 is used as a dawn simulator, the control module 140 controls the color temperatures of the illuminating light to successively vary from 1600K to 12000K, and the brightness variation corresponding to the color temperatures meets an S-curve (sigmoidal curve) as shown in FIG. 4, and the variation time is about 6 hours. Specifically, a starting point of the dawn simulator can be set at some time points such as 6:00 A.M. for the vernal equinox or the autumnal equinox, 5:00 A.M. for the summer solstice, and 6:30 for the winter solstice. The color temperatures and the brightness vary more slowly at a first time interval T1; the color temperatures change every 6 minutes from 2000K, five changed color temperatures in all. The color temperatures and the brightness vary more rapidly at a second time interval T2; the color temperatures change every 4.5 minutes, twenty changed color temperatures in all. The color temperatures vary more slowly at a third time interval T3; the color temperatures change every 12 minutes, four changed color temperatures in all, and then maintain the color temperature of 12000 K. After setting the color temperature variations, the combination of light sources 124 is controlled by the control module 140 to emit the desired brightness corresponding to each of the color temperatures of the illuminating light. The color temperatures and the brightness of the dawn simulator of the embodiment dynamically change. Compared with the conventional tunable lamp just with the changeable brightness, when the dawn simulator of the embodiment is served as a bedside lamp, it has a better effect for easing the melancholia.

Similarly, the illumination apparatus of the present invention can be served as a dusk simulator. The control module can control the color temperatures of the illuminating light to successively vary from 12000K to 1600K, and the brightness variation corresponding to the color temperatures meets the inverted S-curve (reverse-sigmoidal curve), and the duration of the variation is about 6 hours. The variations of the color temperatures and the brightness are opposite to those of the dawn simulator, so no further detail will be provided herein.

In other embodiment of the present invention, the illumination apparatus 100 of the present invention can further be utilized to ease sleep in the afternoon. The control module 140 controls the color temperatures of the illuminating light to linearly vary from 1600K to 12000K, and the color temperatures of the illuminating light linearly varies from 1600K to 12000K preferably from 13:30 to 15:30 in the afternoon, the light can boost mental alertness of an user.

In summary, the illumination apparatus 100 of the present invention employs the combination of light sources 124 to gradually emit the illuminating light of the multiple color temperatures, and the color rendering index of the illuminating light of each color temperature is larger than 90. Moreover, the color difference in Duv of each change of the illuminating light is less than 0.006; thus, it is not detected by the human body. Moreover, the illumination apparatus 100 of the present invention is further capable of controlling the color temperatures of the illuminating light to successively vary from 1600K to 12000K, and the brightness variation corresponding to the color temperatures meets the S-curve, thereby completely simulating the variation of dawn. Similarly, the illumination apparatus of the present invention is further capable of controlling the color temperatures of the illuminating light to successively vary from 12000K to 1600K, and the brightness variation corresponding to the color temperatures meets the inverted S-curve, thereby completely simulating the variation of dusk. Moreover, the illuminating light whose color temperature linearly varies from 1600K to 12000K further can be used to ease sleep in the afternoon.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. An illumination apparatus with gradually changeable color temperatures, the illumination apparatus comprising:
an illumination module utilized to generate an illuminating light having a plurality of different color temperatures; and
a control module utilized to control a color temperature variation of the illuminating light, so that a color difference in Duv corresponding to the variation of the illuminating light is less than 0.006 under the color temperature variation.

2. The illumination apparatus of claim 1, wherein all color rendering indices of the illuminating light corresponding to the different color temperatures are larger than 90.

3. The illumination apparatus of claim 1, wherein the color temperature variation is selected from the group consisting of changes between two arbitrarily adjacent color temperatures from 1600K, 1651K, 1705K, 1762K, 1822K, 1886K, 1954K, 2027K, 2105K, 2188K, 2277K, 2373K, 2476K, 2587K, 2700K, 2836K, 3000K, 3128K, 3293K, 3500K, 3666K, 3878K, 4000K, 4362K, 4500K, 5000K, 5288K, 5700K, 6098K, 6500K, 7147K, 7803K, 8582K, 9529K, 10711K, 12242K, 14322K, 17350K, and 20000K.

4. The illumination apparatus of claim 1, wherein the control module is further utilized to control a brightness variation of the illuminating light.

5. The illumination apparatus of claim 4, wherein the control module controls the color temperatures of the illuminating light to successively vary from 1600K to 12000K, and the brightness variation corresponding to the color temperatures meets an S-curve.

6. The illumination apparatus of claim 4, wherein the control module controls the color temperatures of the illuminating light to successively vary from 12000K to 1600K, and the brightness variation corresponding to the color temperatures meets an inverted S-curve.

7. The illumination apparatus of claim 4, wherein the control module controls the color temperatures of the illuminating light to linearly vary from 1600K to 12000K.

8. The illumination apparatus of claim 7, wherein the color temperatures of the illuminating light linearly varies from 1600K to 12000K from 13:30 to 15:30.

9. The illumination apparatus of claim 1, wherein the illumination module comprises a combination of light sources, the combination of light sources comprising:
a first LED whose main wavelength is 448 nm±20 nm;
a second LED whose main wavelength is 505 nm±20 nm;
a third LED whose main wavelength is 562 nm±20 nm; and
a fourth LED whose main wavelength is 619 nm±20 nm.

10. The illumination apparatus of claim 9, wherein the illumination module further comprises:
a driving module electrically coupled to the combination of light sources and the control module, the driving module utilized to drive the LEDs to illuminate and to control luminous energy distributions of the LEDs according to the control module for emitting the illuminating light with the color temperatures and the brightness.
